(19) United States
(12) Patent Application Publication
(10) Pub. No.: US 2014/0178840 A1
(43) Pub. Date: Jun. 26, 2014

(54) Prosthetic Device

(71) Applicant: Mehri Mafi, San Jose, CA (US)

(72) Inventors: Mehri Mafi, San Jose, CA (US); Maryam Mafi, San Jose, CA (US)

(21) Appl. No.: 14/100,243

(22) Filed: Dec. 9, 2013

Related U.S. Application Data
(60) Provisional application No. 61/848,328, filed on Dec. 26, 2012.

(51) Int. Cl. A61C 13/24; A61C 13/01; A61C 13/08

(52) U.S. Cl. CPC A61C 13/245; A61C 13/082; A61C 13/01
USPC 433/187; 433/184; 433/186

(57) ABSTRACT

A prosthetic device that securely joins with a tissue through the utilization of at least one pressure differential portion, such as suction cups. The pressure differential portion serves to form a vacuum between the device and the tissue for secure attachments. The device comprises a silicone shape and conforms to tissue, such as the gums. An upper portion and a lower portion join with an upper gum and a lower gum, respectively. A mounting surface includes at least one pressure differential portion for fastening to the tissue. An engagement surface is operable to perform functions for the device, including engaging an object, such as food. The upper and lower portion comprise side surfaces with adhesives for additional stability and fastening capacity along a longitudinal axis of the tissue. The device includes an antibacterial composition to inhibit odors. The engagement surface may include an ornamental portion, such as gold.

### CROSS-REFERENCE TO RELATED APPLICATIONS

The present Utility patent application claims priority benefit of the U.S. provisional application for patent Ser. No. 61/848,328 titled “Quick Fix for Dentures,” filed on Dec. 26, 2012 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to prosthetic devices. More particularly, the invention relates to dentures that adhere to gums through an air vacuum.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that teeth of are small, calcified, hard, whitish structures found in the mouth. Teeth function by mechanically breaking down items of food by cutting and crushing them in preparation for swallowing and digestion.

It is known that dentures, also known as false teeth, are prosthetic devices constructed to replace missing teeth, and which are supported by surrounding soft and hard tissues of the oral cavity. Conventional dentures are removable, however there are many different denture designs, some which rely on bonding or clasping onto teeth or dental implants.

Typically, a suction cup is an object that uses negative fluid pressure of air or water to adhere to nonporous surfaces and in the process creates a partial vacuum. Suction cups have a number of commercial and industrial applications. In office and household settings, they are commonly used to affix objects to nonporous vertical surfaces such as refrigerator doors and tiled walls.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A and 1B illustrate top view of an exemplary prosthetic device, where FIG. 1A illustrates an upper portion, and FIG. 1B illustrates a lower portion, in accordance with an embodiment of the present invention; and

FIG. 2 illustrates a top view of an exemplary pair of side surfaces, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

The present invention will now be described in detail with reference to embodiments thereof as illustrated in the accompanying drawings.

There are various types of prosthetic devices that may be provided by preferred embodiments of the present invention. In one embodiment of the present invention, the prosthetic device may join securely with a tissue through a plurality of mechanisms, including, without limitation, suction cups, adhesives, and molded contouring. The prosthetic device may be shaped and dimensioned to conform to any type of the tissue, including, without limitation, a soft and/or hard tissue of the oral cavity, gums, gingiva, and the necks of teeth. In some embodiments, the prosthetic device may yield to the tissue due to the inherent physical properties of softness and malleability. The prosthetic device may help inhibit odor and taste when engaged with the fleshy tissue. The prosthetic device may include, without limitation, dentures, false teeth, dental implants, partial dentures, and complete dentures.

In one embodiment of the present invention, the prosthetic device may include an upper portion and a lower portion. Each portion may be configured to join with an upper tissue section and a lower tissue section, respectively. In this manner, each portion may conform to the shape and movements of the appropriate tissue section for performing the functions of prehension and mastication of food, and performing defensive actions. Each portion may include a mounting surface for securely joining to the tissue. The mounting surface may include at least one pressure differential portion. The at least one pressure differential portion may help adhere each portion to the tissue by utilizing a negative fluid pressure to create a vacuum with the nonporous surface of the tissue. The at least one pressure differential portion may include, without limitation, a suction cup, and a silicone disc with a slight concave surface.

In one embodiment of the present invention, the upper portion and the lower portion may include an engagement surface for providing the chief function of the prosthetic device. The engagement surface may include, without limitation, teeth, molars, an upper set of teeth, and a lower set of teeth. In one embodiment, both the upper portion and the lower portion may include a pair of side surfaces. Each side surface may include an adhesive for joining with a side tissue section, whereby the side surfaces wrap around and conform to the contours of the side tissue section. In some embodiments, the prosthetic device may include decorative features, including, without limitation, various colors, various textures, text, and graphics.

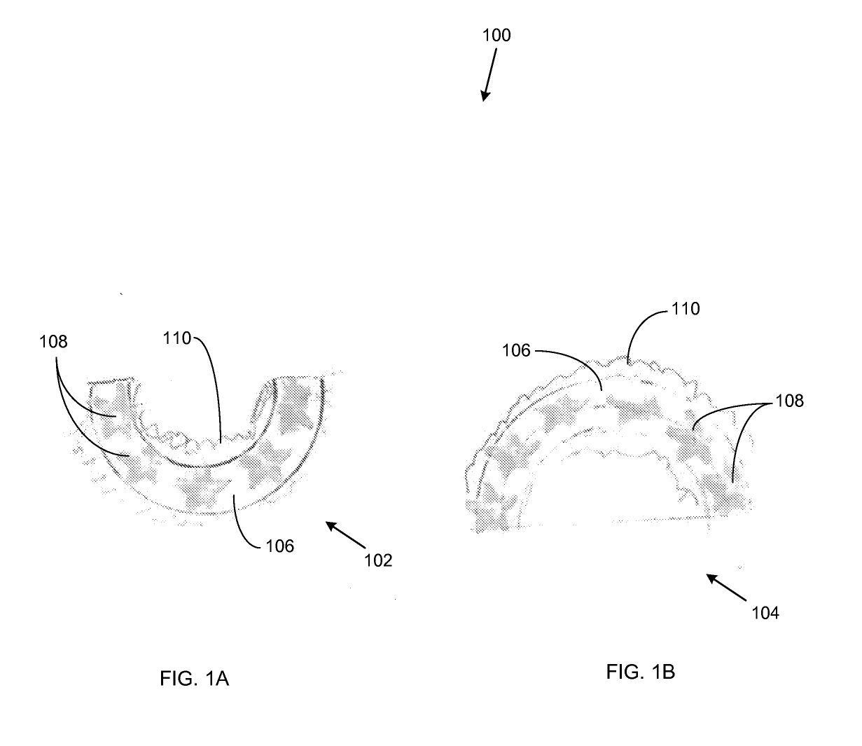

FIGS. 1A and 1B illustrate top view of an exemplary prosthetic device, where FIG. 1A illustrates an upper portion, and FIG. 1B illustrates a lower portion, in accordance with an embodiment of the present invention. In the present invention, a prosthetic device 100 may join securely with a tissue through a plurality of mechanisms, including, without limitation, suction cups, adhesives, friction contouring, and molding. The prosthetic device may be shaped and dimensioned to conform to any type of the tissue, including, without limitation, a soft and/or hard tissue of the oral cavity, gums, gingiva, and the necks of teeth. The silicone material from which the prosthetic device may be fabricated may allow for custom cutting to fit a variety of tissues and gums. In some embodiments, the prosthetic device may yield to the tissue due to the inherent physical properties of softness and malleability. In some embodiments, the prosthetic device may help inhibit odor and taste when engaged with the fleshy tissue. An antibacterial composition may cover the surface of the prosthetic device to help inhibit odors and bacteria.

In one embodiment of the present invention, the prosthetic device may include, without limitation, dentures, false teeth, dental implants, partial dentures, and complete dentures. The prosthetic device may include an upper portion 102 and a lower portion 104. Each portion may be configured to join with an upper tissue section and a lower tissue section, whereby each portion conforms to the movement of the appropriate tissue section for performing the functions of prehension and mastication of food, and defensive actions. In some embodiments, the upper portion may be a separate component from the lower portion. However, in other embodiments, the upper portion and the lower portion may join at a hinge, forming a pivoting motion that conforms to the movement of the mouth. Each portion may include a mounting surface 106 for securely joining to the tissue. In one embodiment of the present invention, the upper portion and the lower portion may include an engagement surface 110 for engaging an object, such as food, and providing the chief function of the prosthetic device. The engagement surface may include, without limitation, teeth, molars, an upper set of teeth, and a lower set of teeth.

In one embodiment of the present invention, the mounting surface may include at least one pressure differential portion 108. The at least one pressure differential portion may help adhere each portion to the tissue by utilizing a negative fluid pressure to create a vacuum with the nonporous surface of the tissue. The at least one pressure differential portion may include, without limitation, a suction cup, and a silicone disc with a slight concave surface. Those skilled in the art, in light of the present teachings, will recognize that the suction cup has a curved surface. When the center of the suction cup is pressed against a flat, non-porous surface, such as the tissue or gum, the volume of the space between the suction cup and the flat surface is reduced, which causes the fluid between the cup and the surface to be expelled past the rim of the circular cup. When a user ceases to apply physical pressure to the center of the outside of the suction cup, the elastic substance of which the cup is made may resume its original, curved shape. Yet, because most of the fluid has already been forced out of the inside of the cup, the cavity which tends to develop between the cup and the flat surface has little to no fluid in it, and therefore lacks pressure. The pressure difference between the atmosphere on the outside of the cup, and the low-pressure cavity on the inside of the cup, is what keeps the cup adhered to the tissue.

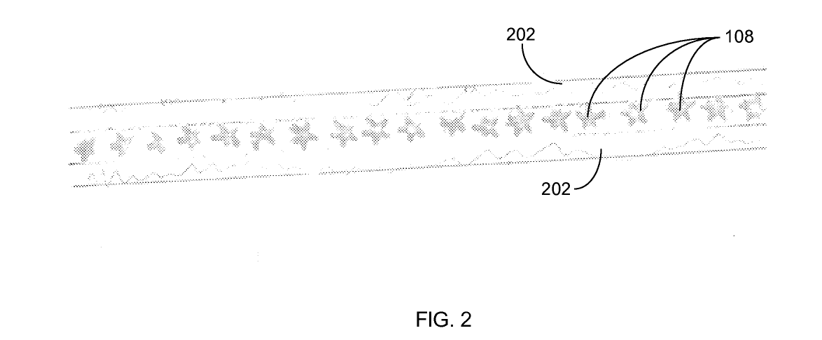

FIG. 2 illustrates a top view of an exemplary pair of side surfaces, in accordance with an embodiment of the present invention. In the present invention, both the upper portion and the lower portion may include a pair of side surfaces 202. Each side surface may include an adhesive for joining with a side tissue section, whereby the side surfaces wrap around and conform to the contours of the side tissue section. In some embodiments, the pair of side surfaces may align along a longitudinal axis of the gums, with each side forming a flap that extends inwardly to form a seal. Suitable materials for the prosthetic device may include, without limitation, silicone.

In one alternative embodiment, the mounting surface and the pair of side surfaces may include an ointment for treating gums and teeth. In yet another alternative embodiment, the at least one pressure differential portion may include a long strip, rather than individual spheres in proximity to each other. In yet another alternative embodiment, the upper portion and the lower portion are attached at a hinge. In yet another alternative embodiment, the engagement portion may include an ornamental portion, such as gold caps, vampire teeth, and colored teeth. In yet another alternative embodiment, the at least one pressure differential portion may detach for facilitated cleaning

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a prosthetic device that adheres to tissue through suction cups according to the present invention will be apparent to those skilled in the art. Various aspects of the invention have been described above by way of illustration, and the specific embodiments disclosed are not intended to limit the invention to the particular forms disclosed. The particular implementation of the prosthetic device that adheres to tissue through suction cups may vary depending upon the particular context or application. By way of example, and not limitation, the prosthetic device that adheres to tissue through suction cups described in the foregoing were principally directed to dentures fabricated from odorless, tasteless material that adhere to gums through a series of suction cups and adhesives implementations; however, similar techniques may instead be applied to individual teeth replacements, where the tooth uses suction cups as part of the mechanism to hold the tooth in, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A device comprising:
an upper portion and a lower portion, said upper portion and said lower portion being configured to be operable to join with a tissue, said upper portion and said lower portion comprising a mounting surface for at least partially engaging said tissue, said mounting surface comprising at least one pressure differential portion for at least partially fastening said upper portion and said lower portion to said tissue, said upper portion and said lower portion further comprising an engagement surface for engaging an object.

2. The device of claim 1, in which said device comprises a prosthetic device, said prosthetic device comprising a denture.

3. The device of claim 2, in which said tissue comprises a gum.

4. The device of claim 3, wherein said upper portion is configured to at least partially conform to the shape of an upper gum, and said lower portion is configured to at least partially conform to the shape of a lower gum.

5. The device of claim 4, in which said at least one pressure differential portion comprises at least one suction cup.

6. The device of claim 5, wherein said suction cup at least partially forms a vacuum with said tissue.

7. The device of claim 6, in which said engagement surface comprises an outer surface of said upper portion and said lower portion.

8. The device of claim 7, in which said engagement surface comprises an ornamental portion.

9. The device of claim 8, in which said ornamental portion comprises gold teeth.

10. The device of claim 9, in which said object comprises a food.

11. The device of claim 10, in which said upper potion and said lower portion comprise a side surface for joining with an upper side section and a lower side section of said tissue.

12. The device of claim 11, wherein said side surface is configured to be operable to align along a longitudinal axis of said tissue.

13. The device of claim 12, in which said device comprises an antibacterial composition for helping to inhibit an odor.

14. The device of claim 13, in which said device comprises a silicone material.

15. A device comprising:
means for orienting a device for mating with a tissue;
means for joining an upper surface and a lower surface with said tissue;
means for engaging a mounting surface with said tissue;
means for fastening at least one pressure differential portion to said tissue; and
means for engaging an object with an engagement surface.

16. A device consisting of:
an upper portion and a lower portion, said upper portion being configured to at least partially conform to the shape of an upper gum, said upper portion comprising an upper denture, said lower portion being configured to at least partially conform to the shape of a lower gum, said lower portion comprising a lower denture, said upper portion and said lower portion further being configured to be operable to join with a tissue, said tissue comprising a gum, said upper portion and said lower portion further comprising a mounting surface for at least partially engaging said tissue, said mounting surface comprising at least one pressure differential portion for at least partially fastening said upper portion and said lower portion to said tissue, said at least one pressure differential portion comprising at least one suction cup, said upper portion and said lower portion further comprising an engagement surface for engaging an object, said object comprising food, said upper portion and said lower portion further comprising a silicone material.
